(19) United States
(12) Patent Application Publication
(10) Pub. No.: US 2014/0060288 A1
(43) Pub. Date: Mar. 6, 2014

(54) TESTING DEVICE AND STORAGE MEDIUM WITH TESTING FUNCTION, AND TESTING METHOD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: XIAO-LI WANG, Shenzhen (CN); HAI-FENG ZHANG, Shenzhen (CN); HUNG-LUN CHIANG, New Taipei (TW); JUN LIU, Shenzhen (CN)

(73) Assignees: HON HAI PRECISION INDUSTRY CO., LTD., New Taipei (TW); HONG FU JIN PRECISION INDUSTRY (ShenZhen) CO., Shenzhen (CN)

(21) Appl. No.: 13/974,120

(22) Filed: Aug. 23, 2013

(30) Foreign Application Priority Data
Aug. 29, 2012 (CN) 2012103120379

(51) Int. Cl. G10H 7/00

(52) U.S. Cl. CPC G10H 7/00
USPC 84/622

(57) ABSTRACT

A testing device for testing timbre of a disc player is provided. The testing device may be contained in a computer, or test equipment. The testing device is electronically connected to the disc player for receiving audio signals from the disc player, and analyzing the audio signals to obtain at least one test value for determining the timbre of the disc player. A testing method applied in the testing device is also provided.

### BACKGROUND

1. Technical Field

The present disclosure relates to testing device and method, and more particularly to a testing device and a non transitory storage medium capable of testing timbre of a disc player, and a method for testing timbre of a disc player.

2. Description of Related Art

Disc player need to be tested before leaving the factory, and conventional method for testing timbre of the disc player includes the following steps: inserting a disc in the disc player; watching the left and right sound tract signal via an oscilloscope; and then, determining whether the signal output by the oscilloscope is a sine wave. However, this method is expensive due to the cost of the oscilloscope.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a testing device in accordance with an embodiment.

FIG. 2 is a flowchart of a testing method in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language, for example, Java, C, or assembly. One or more software instructions in the modules may be embedded in firmware, such as in an EPROM. Modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage system. Embodiments of the present disclosure will be described with reference to the drawings.

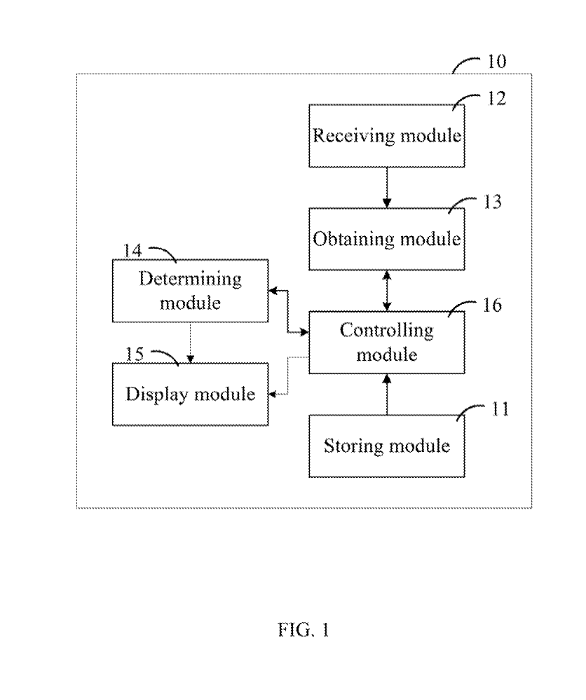

FIG. 1 shows a blocking diagram of a testing device 10 for testing the timbre of a disc player (not shown). The disc player generates audio signals when playing a disc, and outputs the audio signals via left and right sound tracks (not shown). The left and right sound tracks are electronically connected to the testing device 10. The testing device 10 includes a storing module 11, a receiving module 12, an obtaining module 13, a determining module 14, a display module 15, and a controlling module 16. The disc in this embodiment records a predetermined audio file, the disc player is a DVD player.

The storing module 11 stores a number of timbre parameters. The timbre parameters include at least a frequency parameter, a volume parameter, and an SNR(signal-to-noise ratio) parameter. Each timbre parameter has a standard value. In this embodiment, each timbre parameter includes a first standard value corresponding to the left sound track and a second standard value corresponding to the right sound track. The first and second standard values may be the same, or different from each other. Each frequency parameter, each volume parameter and each SNR parameter all further include a number of values corresponding to different sound track respectively, such as left sound track and right sound track.

The receiving module 12 receives audio signals from the disc player, wherein the audio signals may be output from left sound track and right sound track of the disc player.

The obtaining module 13 analyses the audio signals to obtain a test value of each timbre parameter. In detail, the obtaining module 13 generates at least one audio file according to the audio signals. The audio file in this embodiment may be a WAVE file. The obtaining module 13 transforms the audio file using Fast Fourier Transform (time-frequency transformation) to obtain the test value of each timbre parameter for evaluating the timbre of the disc player.

The determining module 14 determines whether the timbre of the disc player is qualified based on the test value of each timbre parameter. When the timbre of the disc player is qualified, the controlling module 16 controls the display module 15 to display a message for informing the testing personnel that the disc player is qualified. When the timbre of the disc player is unqualified, the controlling module 16 controls the display module 15 to display a message for informing the testing personnel that the disc player is unqualified.

In this embodiment, when a difference value between the test value of each timbre parameter and the corresponding standard value falls within a predetermined range, the determining module 14 determines that the timbre of the disc player is qualified. When a difference value between the test value of each timbre parameter and the corresponding standard value does not fall within a predetermined range, the determining module 14 determines that the timbre of the disc player is unqualified. Each difference value c in this embodiment may be calculated by an equation: c=|a−b|/b×100%, wherein “a” represents the test value of each timbre parameter, and “b” represents each standard value of each timbre parameter.

In other embodiments, when the test value of each timbre parameter is less than or equal to the corresponding standard value, the determining module 14 determines the timbre of the disc player is qualified. When the test value of each timbre parameter is greater than the corresponding standard value, the determining module 14 determines the timbre of the disc player is unqualified.

The controlling module 16 controls the display module 15 to display the test value for informing the state of the disc player. The display module 15 may be a display screen integrated within the testing device 10, or may be a display electrically connected to the testing device 10.

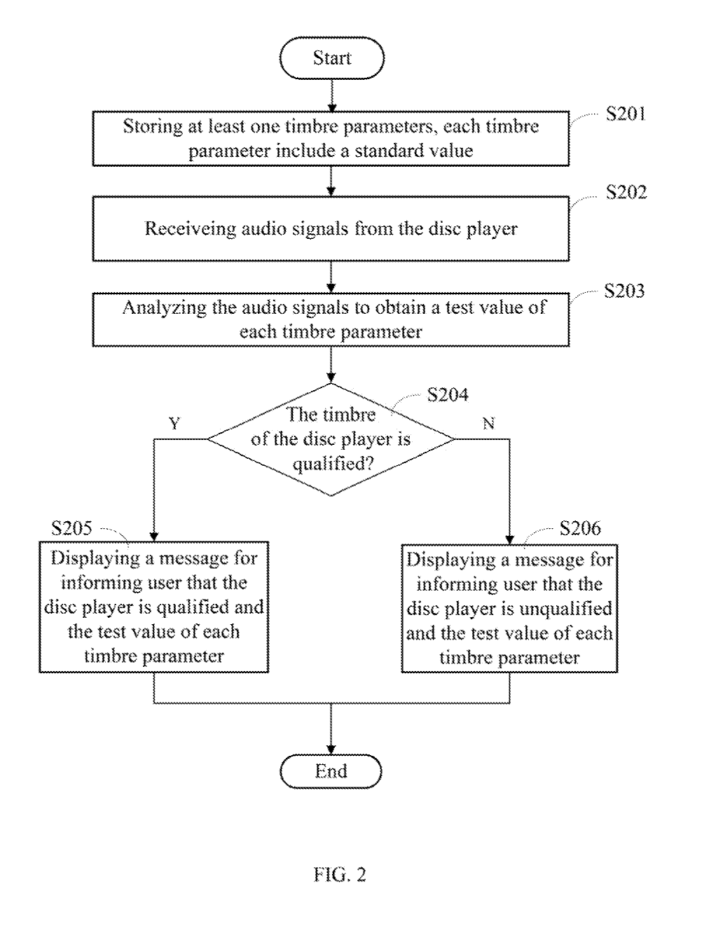

FIG. 2 shows a testing method for testing a disc player. The method is applied in the testing device 10. The testing device 10 may be contained in a computer, or may be an independent device. The method includes the following steps:

In step S201, the storing module 11 stores a number of timbre parameters. The timbre parameters include at least a frequency parameter, a volume parameter, and a signal-to-noise ratio (SNR) parameter. In this embodiment, each timbre parameter includes a first standard value corresponding to the left sound track and a second standard value corresponding to the right sound track. The first and second standard values may be the same, or different from each other. Each frequency parameter, each volume parameter and each SNR parameter all further include different sound tracks, such as left sound track and right sound track.

In step S202, the receiving module 12 receives audio signals from the disc player, wherein the audio signals may be output from left sound track and right sound track of the disc player.

In step S203, the obtaining module 13 analyses the audio signals to obtain a test value of each timbre parameter. In detail, the obtaining module 13 generates at least one audio file according to the audio signals. The audio file in this embodiment may be a WAVE file. The obtaining module 13 transforms the audio file using Fast Fourier Transform (time-frequency transformation), and obtains the test value of each timbre parameter for evaluating the timbre of the disc player.

In step S204, the determining module 14 determines whether the timbre of the disc player is qualified based on the test value of each timbre parameter. When the timbre of the disc player is qualified, step S205 is implemented. When the timbre of the disc player is unqualified, step S206 is implemented.

In this embodiment, when a difference value between each test value of each timbre parameter and the corresponding standard value falls within a predetermined range, the determining module determines that the timbre of the disc player is qualified. When a difference value between each test value of each timbre parameter and the corresponding standard value does not fall within a predetermined range, the determining module 14 determines that the timbre of the disc player is unqualified. Each difference value c in this embodiment may be express by the equation: c=|a−b|/b×100%. In the equation, the “a” represents each test value of each timbre parameter, the “b” represents each standard value of each timbre parameter.

In other embodiments, when each test value of each timbre parameter is less than or equal to the corresponding standard value, the determining module 14 determines the timbre of the disc player is qualified. When each test value of each timbre parameter is more than the corresponding standard value, the determining module 14 determines the timbre of the disc player is unqualified.

In step S205, the controlling module 12 controls the display module 15 to display a message for informing the testing personnel that the disc player is qualified and the test value of each timbre parameter.

In step S206, the controlling module 12 controls the display module 15 to display a message for informing the testing personnel that the disc player is unqualified and the test value of each timbre parameter.

Although information as to, and advantages of, the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A testing device for testing timbre of a disc player, comprising:
a display module;
a storing module storing at least one timbre parameter;
a receiving module receiving audio signals from the disc player;
an obtaining module analyzing the audio signals to obtain at least one test value of the at least one timbre parameter; and
a controlling module controlling the display module to display the test value of the at least one timbre parameter.

2. The testing device of claim 1, wherein the at least one timbre parameter comprises a frequency parameter, a volume parameter, and an SNR (signal-to-noise ratio) parameter.

3. The testing device of claim 2, wherein the frequency parameter further comprises a frequency parameter of a left sound track and a frequency parameter of a right sound track, the volume parameter further comprises a volume parameter of a left sound track and a volume parameter of a right sound track, and the SNR parameter further comprises a SNR parameter of a left sound track and a SNR parameter of a right sound track.

4. The testing device of claim 1, further comprising a determining module for determining whether the timbre of the disc player is qualified based on the test value obtained by the obtaining module; wherein when the timbre of the disc player is qualified, the controlling module controls the display module to display a message for informing a testing personnel that the disc player is qualified; when the timbre of the disc player is not qualified, the controlling module controls the display module to display a message for informing the testing personnel that the disc player is unqualified.

5. The testing device of claim 4, wherein each timbre parameter further comprises a standard value, when the test value of each timbre parameter is less than or equal to the corresponding standard value, the determining module determines the timbre of the disc player is qualified; when each test value of each timbre parameter is greater than the corresponding standard value, the determining module determines the timbre of the disc player is unqualified.

6. The testing device of claim 4, wherein each timbre parameter further comprises a standard value, when a difference value between each test value of each timbre parameter and the corresponding standard value falls within a predetermined range, the determining module determines the timbre of the disc player is qualified; when a difference value between each test value of each timbre parameter and the corresponding standard value does not fall within a predetermined range, the determining module determines the timbre of the disc player is unqualified.

7. The testing device of claim 6, wherein each difference value c is calculated by aa equation: c=|a−b|/b×100%, wherein “a” represents each test value of each timbre parameter, “b” represents each standard value of each timbre parameter.

8. The testing device of claim 1, wherein the obtaining module is used for generating at least one audio file according to the audio signals, and further transforming the audio file using Fast Fourier Transform to obtain the test value of each timbre parameter for evaluating the timbre of the disc player.

9. A testing method for testing timbre of a disc player, comprising steps of:
storing at least one timbre parameter;
receiving audio signals from the disc player;
analyzing the audio signals to obtain at least one test value of the at least one timbre parameter; and
displaying the test value of the at least one timbre parameter.

10. The testing method of claim 9, wherein the at least one timbre parameter comprises a frequency parameter, a volume parameter, and a SNR parameter.

11. The testing method of claim 10, wherein the frequency parameter further comprises a frequency parameter of a left sound track and a frequency parameter of a right sound track, the volume parameter further comprises a volume parameter of a left sound track and a volume parameter of a right sound track, and the SNR parameter further comprises a SNR parameter of a left sound track and a SNR parameter of a right sound track.

12. The testing method of claim 9, further comprising steps of:
determining whether the timbre of the disc player is qualified based on the test value obtained by the obtaining module;
when the timbre of the disc player is qualified, the controlling module controls the display module to display a message for informing testing personnel that the disc player is qualified;
when the timbre of the disc player is not qualified, the controlling module controls the display module to display a message for informing testing personnel that the disc player is unqualified.

13. The testing method of claim 12, wherein each timbre parameter further comprises a standard value, when the test value of each timbre parameter is less than or equal to the corresponding standard value, the determining module determines the timbre of the disc player is qualified; when each test value of each timbre parameter is greater than the standard value, the determining module determines the timbre of the disc player is unqualified.

14. The testing method of claim 12, wherein each timbre parameter further comprises a standard value, when a difference value between each test value of each timbre parameter and the corresponding standard value falls within a predetermined range, the determining module determines the timbre of the disc player is qualified; when a difference value between each test value of each timbre parameter and the corresponding standard value does not fall within a predetermined range, the determining module determines the timbre of the disc player is unqualified.

15. The testing method of claim 9, wherein the step of analyzing the audio signals to obtain a test value further comprising steps of:
generating at least one audio file according to the audio signals;
transforming the audio file using Fast Fourier Transform to obtain the test value of each timbre parameter for evaluating the timbre of the disc player.

16. The testing method of claim 9, wherein each difference value c is calculated by an equation: c=|a−b|/b×100%, wherein “a” is each test value of each timbre parameter, “b” is each standard value of each timbre parameter.

17. A non transitory storage medium storing a plurality of modules, the plurality of module s comprising instructions executable by a processor of an electronic device to perform a testing method for testing timbre of a disc player, the testing method comprising:
storing at least one timbre parameter;
receiving audio signals from the disc player;
analyzing the audio signals to obtain at least one test value of the at least one timbre parameter; and
displaying the test value of the at least one timbre parameter.

18. The non transitory storage medium of claim 17, wherein the testing method further comprising steps of:
determining whether the timbre of the disc player is qualified based on the test value obtained by the obtaining module;
when the timbre of the disc player is qualified, the controlling module controls the display module to display a message for informing testing personnel that the disc player is qualified;
when the timbre of the disc player is not qualified, the controlling module controls the display module to display a message for informing testing personnel that the disc player is unqualified.

19. The non transitory storage medium of claim 17, wherein each timbre parameter further comprises a standard value, when the test value of each timbre parameter is less than or equal to the corresponding standard value, the determining module determines the timbre of the disc player is qualified; when each test value of each timbre parameter is greater than the standard value, the determining module determines the timbre of the disc player is unqualified.

20. The non transitory storage medium of claim 17, wherein each timbre parameter further comprises a standard value, when a difference value between each test value of each timbre parameter and the corresponding standard value falls within a predetermined range, the determining module determines the timbre of the disc player is qualified; when a difference value between each test value of each timbre parameter and the corresponding standard value does not fall within a predetermined range, the determining module determines the timbre of the disc player is unqualified.
